(19) United States
(12) Patent Application Publication
(10) Pub. No.: US 2012/0325619 A1
(43) Pub. Date: Dec. 27, 2012

(54) WORK TREATING APPARATUS

(75) Inventors: Taishi Nakamura, Kanonji-shi (JP); Shinichi Ishikawa, Kanonji-shi (JP); Jun Okuda, Kanonji-shi (JP)

(73) Assignee: UNICHARM CORPORATION, Ehime (JP)

(21) Appl. No.: 13/581,164

(22) PCT Filed: Mar. 16, 2011
(86) PCT No.: PCT/JP2011/001562

§ 371 Date: Aug. 24, 2012

(30) Foreign Application Priority Data
Mar. 16, 2010 (JP) 2010-059939

(51) Int. Cl. B65G 15/30

(52) U.S. Cl. 198/339.1

(57) ABSTRACT

A work treating apparatus includes an injection unit for injecting pressurized steam jets evenly to a work without dropping a temperature of pressurized steam jets. The apparatus includes a conveyor for conveying the work in a machine direction and an injection unit for injecting superheated and pressurized steam jets to the work. The injection unit has a lower surface including a plurality of injection orifices in a cross direction. The conveyor is flexible and includes a first mesh belt facing to an upper surface side of the work and a second mesh belt facing to a lower surface side of the work. The first and second mesh belts sandwich the work therebetweeen to convey the work in the machine direction. The lower surface comes in slidable contact with the first mesh belt to curve at least the first mesh belt of the first and second mesh belts downward.

### TECHNICAL FIELD

The present disclosure relates to apparatus for treatment of a work such as a fibrous web or a liquid-absorbent structure and more particularly to work treating apparatus provided with an injection unit adapted to inject pressurized steam.

### RELATED ART

Work treating apparatus provided with an injection unit adapted to inject pressurized steam from an injection plate toward a work is known. For example, PATENT DOCUMENT 1 discloses a work treating apparatus adapted to inject pressurized steam from injection orifices to a laminated sheet web comprising upper and lower fibrous webs and liquid-absorbent materials sandwiched between these fibrous webs so that the liquid-absorbent materials may be subjected to press working in a wetted state. PATENT DOCUMENT 2 discloses a work treating apparatus adapted to convey a work sandwiched between upper and lower mesh belts in a machine direction and to inject pressurized steam from the injection unit to the work surface.

### CITATION LIST

### Patent Literature

[PATENT DOCUMENT 1] JP 54-123293 A
[PATENT DOCUMENT 2] JP 2004-238785 A

### SUMMARY OF INVENTION

### Problem to be Solved by the Invention

In the case of the work treating apparatus disclosed in PATENT DOCUMENT 1, liquid-absorbent materials can be subjected to press work in a wetted state and thereby fibrous webs covering the liquid-absorbent materials from above can be kept in close contact with the liquid-absorbent materials. In this way, fine particles of the liquid-absorbent materials can be prevented from leaking through the upper surface and the laminated sheet can be protected against being hardened. In the case of the work treating apparatus disclosed in PATENT DOCUMENT 2, pressurized steam is injected to a work through openings of the mesh belt and thereby the work's surface can be protected against being damaged.

However, in the two sets of work treating apparatus disclosed in PATENT DOCUMENTS 1 and 2, the injection orifices are spaced from a work by a given distance and, in consequence, injected pressurized steam may be cooled before reaching the work surface and form drops of water accumulating on the laminated sheet. As a result, pressurized steam could not reach liquid-absorbent materials sandwiched between the fibrous webs. In the case of PATENT DOCUMENT 2, even when pressurized steam is injected to the work from the injection orifices kept in slidable contact with the mesh belt in order to prevent the temperature of pressurized steam from dropping, it is impossible to inject pressurized steam to a work at a constant temperature if the mesh belt is knitted one. It is for the reason that, in such a case, the region of the mesh belt adapted to come in contact with the work surface includes undesirable irregularities.

### Measure to Solve the Problem

At least a first aspect of the present invention is characterized in features as will be described below: a work treating apparatus having a machine direction, a cross direction being orthogonal to the machine direction, comprising a conveyor serving to convey a work in the machine direction and an injection unit serving to inject superheated and pressurized steam jets to the work.

In this apparatus, the injection unit has a lower surface provided with a plurality of injection orifices arranged in the cross direction; the conveyor is flexible and comprises a first mesh belt facing to an upper surface of the work and a second mesh belt facing to a lower surface of the work wherein the first and second mesh belts cooperate with each other to sandwich the work therebetweeen and to convey the work in the machine direction; and the lower surface comes in slidable contact with the first mesh belt to bend at least the first mesh belt of the first and second mesh belts downward.

### BRIEF DESCRIPTION OF DRAWINGS

FIG. 1 is a perspective view partially showing work treating apparatus according to a first embodiment of the present invention.

FIG. 2 is a perspective view of a steam piping unit of the work treating apparatus.

FIG. 3 is a perspective view of an injection plate of the work treating apparatus.

FIG. 4 is a sectional view of the injection plate taken along the line IV-IV in FIG. 3.

FIG. 5 is a partially enlarged diagram illustrating a region enclosed by dashed-dotted line in FIG. 4.

FIG. 6 is a sectional view of a injection plate taken along the line VI-VI in FIG. 3.

FIG. 7 is a sectional view of the work treating apparatus taken along the line VII-VII in FIG. 1.

FIG. 8 is a perspective view partially showing the work treating apparatus according to a second embodiment of the present invention.

FIG. 9 is a perspective view partially showing the work treating apparatus according to a third embodiment of the present invention.

FIG. 10 is a perspective view partially showing the work treating apparatus according to a fourth embodiment of the present invention.

### DETAILED DESCRIPTION OF THE PREFERRED EMBODIMENTS

### First Embodiment

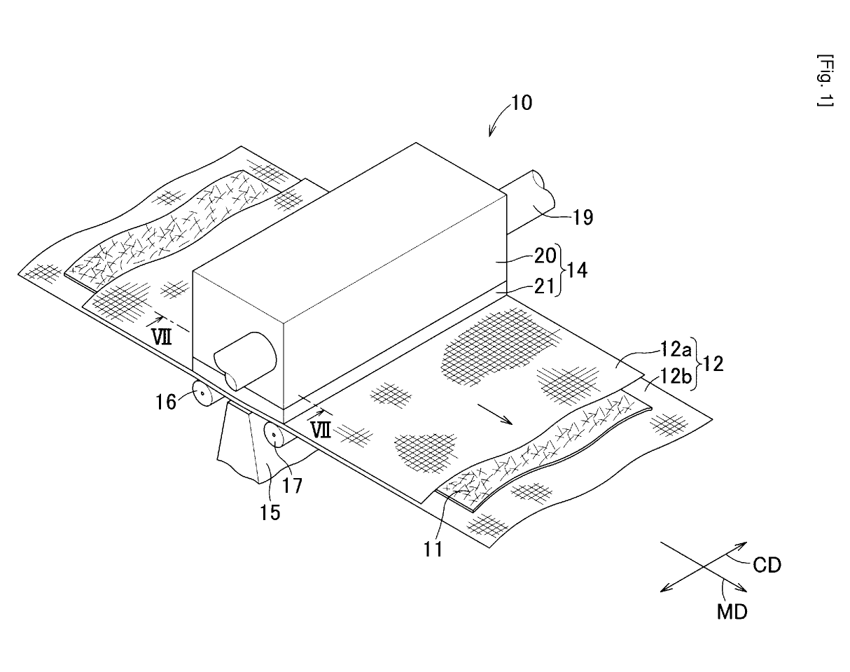

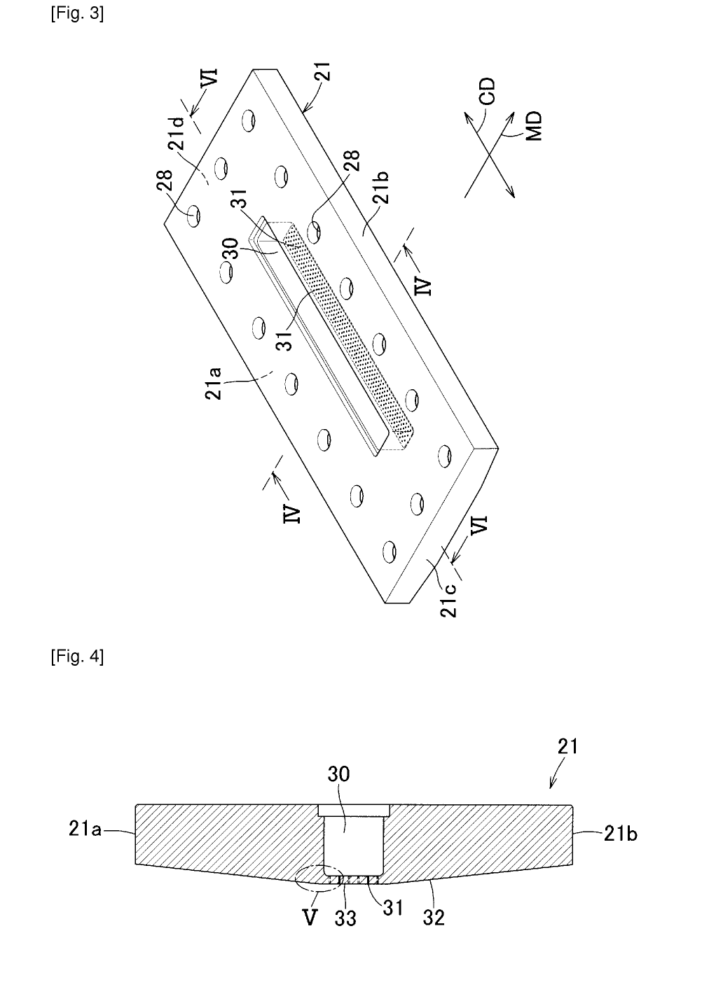

In FIGS. 1 and 3, a machine direction of the work treating apparatus 10 is designated by MD and a cross direction being orthogonal to the machine direction MD is designated by CD.

Referring to FIGS. 1 through 3, work treating apparatus 10 comprises a conveyor 12 serving to convey the work 11 such as a fibrous web in the machine direction MD and an injection unit 14 provided with a plurality of injection orifices 31 (See FIG. 3) serving to inject superheated and pressurized steam jets toward the conveyor 12 which is below the injection orifices 31. Below the conveyor 12, a suction device 15 is provided to suck pressurized steam jets injected from the injection unit 14 and having passed through the conveyor 12 and the work 11. The term “work 11” used herein means an object to be treated or worked upon and, in the embodiments of the present invention, the term means various sheet members of known art widely used as stock materials for sanitary articles such as a laminated sheet comprised of single or multi-layered thermoplastic fibrous webs and liquid-absorbent materials sandwiched between these webs.

The conveyor 12 comprises a pair of endless belts circulating in one direction, i.e., first and second mesh belts 12a, 12b adapted to convey the work 11 sandwiched therebetween in the machine direction MD and, to this end, these mesh belts 12a, 12b are supported and driven by a plurality of feed rolls to run in the machine direction MD. More specifically, the conveyor 12 are supported and driven by at least a pair of feed rolls, i.e., first and second feed rolls 16, 17 underlying the conveyor 12 and respectively located on both sides in the machine direction MD of the injection unit 14. It should be appreciated here that, in the course of conveying the work 11 in the machine direction MD, the conveyor 12 may be adapted to compress the work 11 in its thickness direction in addition to sandwiching the work 11.

The first and second mesh belts 12a, 12b are flexible and may be formed, for example, by a metallic wire product made of stainless alloy or bronze, a plastic product made of woven fibers such as polyester fibers or aramid, or by a perforated metallic plate. According to the present embodiment, the open area ratio of the first and second mesh belts 12a, 12b may be in a range of about 10 to about 85%, their wire diameter may be in a range of about 0.03 to about 5.0 mm and their mesh density may be in a range of about 2 to about 600 per inch. It should be appreciated here that an open area ratio, a wire diameter and a mesh density of the first and second mesh belts may be appropriately set by skilled artisans depending on various factors such as steam pressure of the pressurized steam jets and materials or structure of the work. The first and second mesh belts 12a, 12b may be different from each other in the open area ratio and/or in the mesh density. For example, the first mesh belt 12a may have a mesh density higher than that of the second mesh belt 12b.

The injection unit 14 comprises the steam piping unit 20 having a steam supply pipe 19 into which superheated and pressurized steam supplied from a steam supply unit 18 such as a boiler is introduced and an injection plate 21 fixed to the steam piping unit 20. Instead of separately providing the steam piping unit 20 and the injection plate 21, these two members may be formed as a single member so far as desired superheated and pressurized steam jets can be injected.

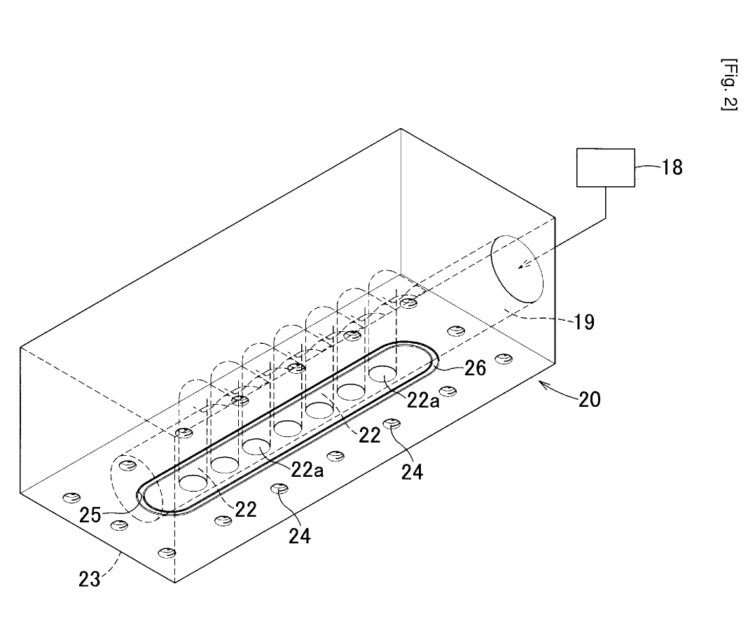

Referring to FIG. 2, the steam piping unit 20 is generally rectangular-shaped and contains therein the pressurized steam supply pipe 19 extending in the cross direction CD and communicating with a plurality of branch pipes 22 arranged at regular intervals in the cross direction CD. These branch pipes 22 communicate with the steam supply pipe 19 at a level higher than a central axis of the steam supply pipe 19 and extend upstream as viewed in the machine direction MD then bend to extend downward. A bottom wall 23 of the steam piping unit 20 are provided along its periphery with a plurality of threaded holes 24 generally at regular intervals and in its central region with a groove 25 so shaped relatively long in the cross direction CD to encircle a group of open ends 22a of the branch pipes 22. The groove 25 is provided with an O-ring 26 serving as a leak-barrier against the pressurized steam.

Referring to FIG. 3, the injection plate 21 is a rectangular plate-shaped member and a top wall thereof facing the bottom wall 23 of the steam piping unit 20 is provided along its periphery with a plurality of holes 28 associated with the threaded holes 24 of the steam piping unit 20. The steam piping unit 20 and the injection plate 21 are fixed to each other by means of bolts (not shown) extending through the respective threaded holes 24 and the associated holes 28. The injection plate 21 is formed in its central region with a steam receiving depression 30 communicating with the open ends 22a of the respective branch pipes 22 so that the pressurized steam may flow from the open ends 22a of the respective branch pipes 22 into the steam receiving depression 30.

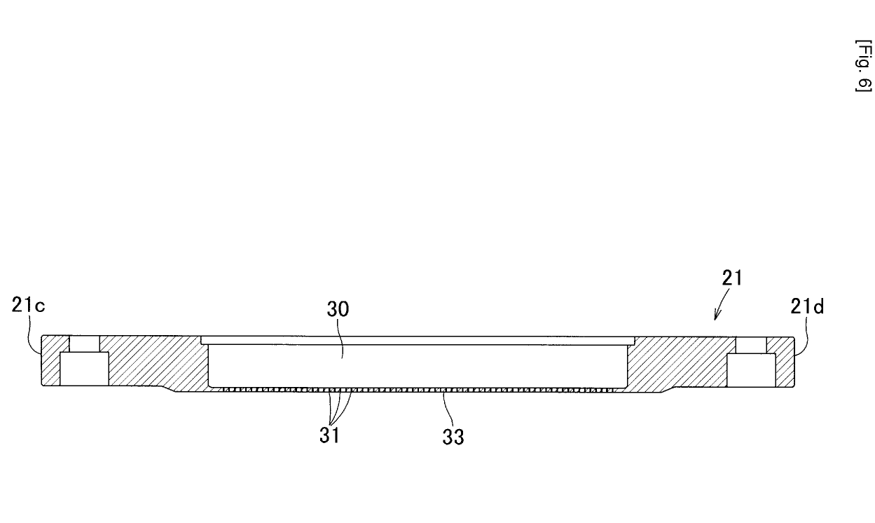

Referring to FIGS. 4 through 6, the steam receiving depression 30 is formed through its bottom wall with a plurality of injection orifices 31 arranged generally in zigzag-pattern in the cross direction CD. A bottom surface 32 of the injection plate 21 comprises a central section 33 corresponding to the central region of the injection plate 21 described above and upstream and downstream sections each extending downward from each of upstream and downstream edges 21a, 21b in the machine direction MD toward the central section and the central section being generally horizontal. In other words, the bottom surface 32 as a whole is convex downward. In this embodiment, the orifice diameter of the injection orifice 31 is preferably in a range of about 0.1 to about 0.2 mm and the pitch at which the injection orifices 31 are arranged is preferably in a range of about 0.5 to about 10.0 mm. However, it should be appreciated here that such factors may be appropriately set by skilled artisans depending on factors such as materials of the work. A cross-sectional shape of the injection orifice 31 is not limited to a circular shape but may be selected from various polygonal cross-sectional shapes. It is also possible without departing from the scope of the invention to shape upper or lower portion of the injection orifice 31 in inverted cone or pyramid so that convergence behavior of injected pressurized steam jets and workability of the apparatus may be improved.

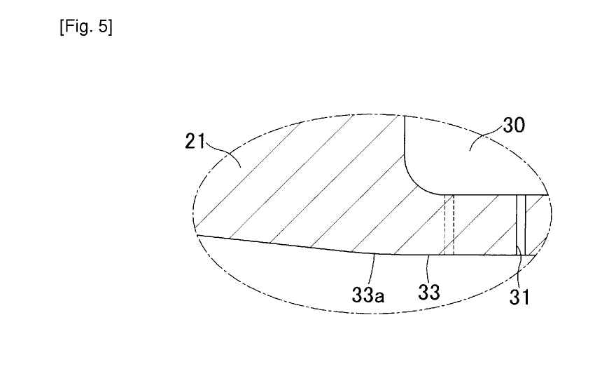

Referring to FIG. 5, on the lower surface 32 of the injection plate 21, a border 33a between the central section 33 and the upstream section is smoothly curved without any corners so that undesirable abrasion of the lower surface 32 and the first mesh belt 12a due to friction therebetween may be restricted and, in addition, the edge 33a of the central section 33 would not be caught by meshes of the first mesh belt 12a to stop conveyance.

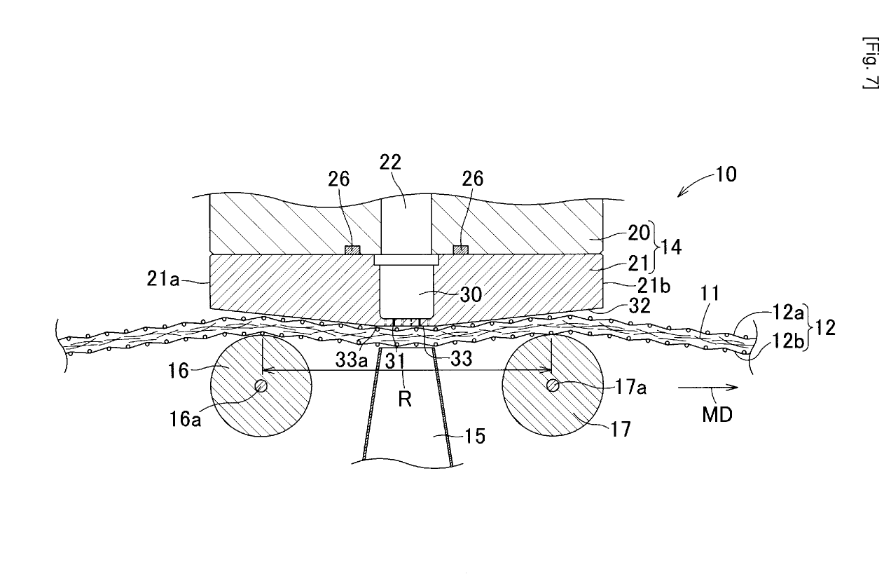

Referring to FIG. 7, the injection plate 21 of the injection unit 14 injects pressurized steam jets toward the work 11 as the lower surface 32 of the injection plate 21 slides along the first mesh belt 12a. Specifically, the first feed roll 16 and the second feed roll 17 lying upstream and downstream of the injection unit 14 as seen in the machine direction MD, respectively, are located so that these feed rolls 16, 17 may slightly push upward a given segment of the conveyor 12 and consequently a region R defined between the first and second feed rolls 16, 17 immediately below the lower surface 32 of the injection plate 21 may be tensioned more intensely than the remaining segment. The lower surface 32 of the injection plate 21 slidably comes in contact with the region R to bend the region R slightly or gently downward and, in consequence, the first mesh belt 12a is partially deformed and bent. While the lower surface 32 usually forces the region R as a whole, i.e., the corresponding regions of the first mesh belt 12a, the work 11 and the second mesh belt 12b to be bent downward as illustrated, it is possible to use a harder mesh belt as the second mesh belt 12b than the first mesh belt 12a to deform the first mesh belt 12a of the first and second mesh belts 12a, 12b only in bent state. Though not illustrated, the lower surface 32 of the injection plate 21 may be located at a level lower than the respective central axes 16a, 17a of the first and second feed rolls 16, 17 to force the lower surface 32 in further tightly slidable contact with the first mesh belt 12a.

When the pressurized steam jets are injected from the injection orifices 31 opening in the lower surface 32 of the injection plate 21 toward the work 11, a distance between the open ends of the respective injection orifices 31 and the work 11 is substantially zero. In consequence, the pressurized steam jets can be injected from the injection orifices 31 to the work 11 without any leakage, i.e., at the optimum injection efficiency. In the course of continuously treating the work 11, more or less air flow would otherwise be induced by travel of the conveyor 12 in the machine direction MD and such air flow would be apt to cool the vicinity of the injection orifices 31 of the lower surface 32. Particularly when the work 11 is significantly spaced from the injection orifices 31, the pressurized steam jets would be cooled to form drops of water accumulating on the surface of the work 11. However, according to the present embodiment, the pressurized steam jets can be injected directly to the work 11 without contact with ambient air and the pressurized steam jets would not be cooled to form drops of water accumulating on the surface of the work 11. In addition, the work treating apparatus 10 according to the present embodiment is adapted to inject the pressurized steam jets to the work 11 via the first mesh belt 12a so that the work 11 may be injected with the pressurized steam jets under constant conditions such as the distance from the injection orifices 31 to the work 11, the temperature of the pressurized steam jets and the quantity of injected steam jets per unit time. If the injection orifices 31 are keep in slidable contact with the work 11 without interposing the first mesh belt 12a, fibers constituting the work 11 might be partially fusion-bonded one to another when a temperature in the vicinity of the injection orifices 31 of the injection plate 21 is higher than a melting point of the work 11. Furthermore, when thickness of the work 11 is uneven, the injection plate 21 partially can not be kept in slidable contact with the work 11 and injection of the pressurized steam jets to the work 11 can not be stabilized. In addition, in such a case, surface fibers in the region coming in slidable contact with the injection plate 21 may be disordered, leading to deterioration of the product quality.

As has previously been described, the lower surface 32 of the injection plate 21 is not merely kept in slidable contact with the first mesh belt 12a, in the region R defined between the first and second feed rolls 16, 17 and subjected to a tension higher than in the remaining region, the lower surface 32 of the injection plate 21 comes in slidable contact with the first mesh belt 12a in the manner that the lower surface 32 forces the first mesh belt 12a to be slightly bend downward during injection of the pressurized steam. Consequentially, even if the first mesh belt 12a is formed of a knitted polyester fiber web or the like and its surface has irregularities, the work 11 can be evenly and reliably injected with the pressurized steam. Of the conveyor 12, in order to deform at least the first mesh belt 12a in a desired curved shape, the first mesh belt 12a has hardness lower than that of the lower surface 32 of the injection plate 21, more specifically, the lower surface 32 of the injection plate 21 preferably has hardness Hv in a range of about 300 to about 1200 and the first mesh belt 12a preferably has hardness lower than this level.

### Second Embodiment

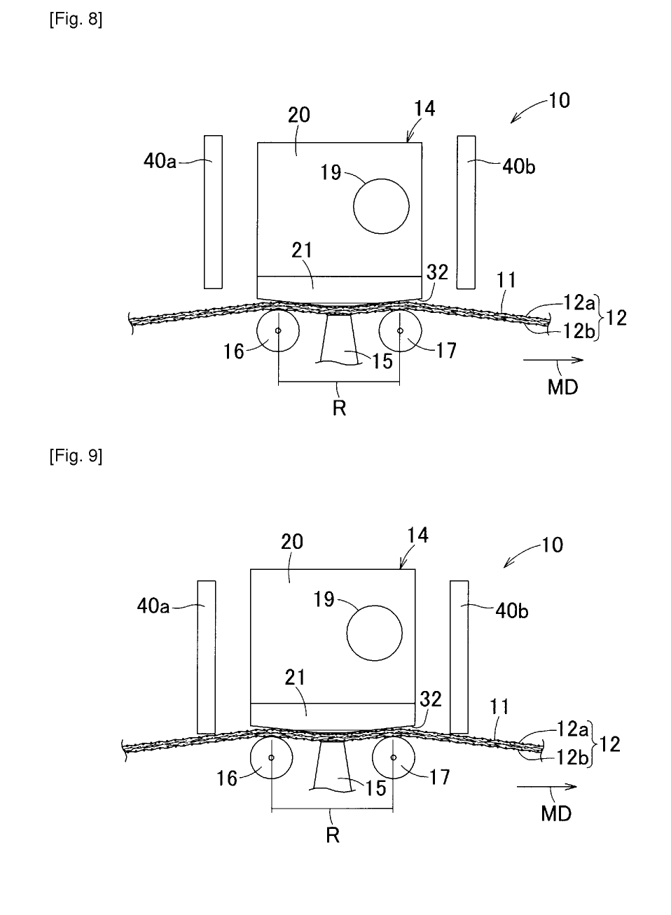

FIG. 8 shows a work treating apparatus 10 according to a second embodiment of the present invention. In the basic construction, the work treating apparatus 10 according to the second embodiment is generally similar to that according to the first embodiment and therefore description will be limited to the features of the second embodiment differing from the first embodiment.

Referring to FIG. 8, a pair of bulkheads 40a, 40b is provided on both sides of the injection unit 14 in the machine direction MD at a distance from the conveyor 12. The bulkheads 40a, 40b advantageously function to prevent air from flowing into the region R, to prevent the temperature in the vicinity of the injection orifices 31 of the lower surface 32 from dropping, to prevent the temperature of the pressurized steam jets injected from the injection orifices 31 from dropping and thereby to allowing the pressurized steam jets maintained at a desired temperature to be injected to the work 11. While any one of these bulkheads 40a, 40b may be located on upstream or downstream to achieve the expected effect, the bulkhead 40a is preferably located on upstream since the air is apt to flow into the region R in the direction in which the work 11 is conveyed.

### Third Embodiment

FIG. 9 shows a work treating apparatus 10 according to a third embodiment of the present invention. In the basic construction, the work treating apparatus 10 according to the third embodiment is generally similar to that according to the first embodiment and therefore description will be limited to the features of the third embodiment differing from the first embodiment.

Referring to FIG. 9, respective lower surfaces of the bulkheads 40a, 40b are in contact with the first mesh belt 12a of the conveyor 12 according to the present embodiment. According to the present embodiment, it is possible to prevent the air from flowing into the region R in the machine direction MD as the conveyor 12 travels. In this way, dropping of the temperature in the vicinity of the injection orifices 31 of the lower surface 32 can be restricted and dropping of the temperature of the pressurized steam jets injected from the injection orifices 31 can be more reliably restricted.

### Fourth Embodiment

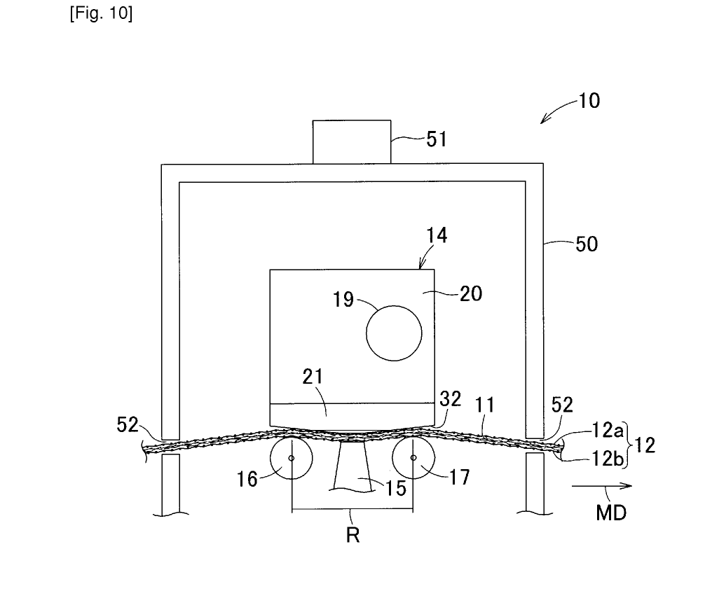

FIG. 10 shows a work treating apparatus 10 according to a fourth embodiment of the present invention. In the basic construction, the work treating apparatus 10 according to the fourth embodiment is substantially similar to that according to the first embodiment and therefore description will be limited to the features of the fourth embodiment differing from the first embodiment.

Referring to FIG. 10, the work treating apparatus 10 is provided with a heating box 50 enclosing the injection unit 14 as a whole and the region R of the conveyor 12 according to the present embodiment. The heating box 50 is adapted to maintain its interior at a predetermined temperature by a heater 51 and formed with a pair of slots 52 allowing the conveyor 12 to pass therethrough. The injection unit 14 as a whole and the region R of the conveyor 12 are generally isolated from the ambient air and the interior of the heating box 50 is maintained at a predetermined temperature. In this way, the predetermined temperature can be maintained at the predetermined level and the pressurized steam jets at the predetermined temperature can be injected to the work 11 without dropping of the temperature of the pressurized steam jets injected from the injection orifices 31 before the steam jets is injected to the work 11.

As has previously been described, the work treating apparatus 10 according to the present invention is not used for any specific treatment but may be used in various fields of treatment such as fusion-bonding of fibers having relatively low fusion temperatures, texture treatment of nonwoven fabric sheets and cleaning of textile oil.

The terms “first” and “second” herein are used merely for distinguishing between similar elements.

The aspects of the present invention described above may be arranged in at least the following item(s):

(i) A work treating apparatus having a machine direction, a cross direction being orthogonal to the machine direction, comprising a conveyor serving to convey a work in the machine direction and an injection unit serving to inject superheated and pressurized steam jets to the work, wherein:

the injection unit has a lower surface provided with a plurality of injection orifices arranged in the cross direction;

the conveyor is flexible and comprises a first mesh belt facing to an upper surface of the work and a second mesh belt facing to a lower surface of the work wherein the first and second mesh belts cooperate with each other to sandwich the work therebetweeen and to convey the work in the machine direction; and

the lower surface comes in slidable contact with the first mesh belt to bend at least the first mesh belt of the first and second mesh belts downward.

The aspect of the present invention described in the above item (i) may provide one or more of the following advantageous effects:

When the lower surface of the injection unit forces the first mesh belt to be curved downward as the lower surface is being in slidable contact with the first mesh belt, there is generally no distance between the injection orifices and the work and a temperature of pressurized steam jets would not drop. In this way, a high efficiency of injection is assured. The lower surface of the injection unit is not only kept in slidable contact with the first mesh belt but also forces the first mesh belt to be convexly deformed downward and thereby ensures that the work surface can be treated with pressurized steam jets kept at a constant temperature even if the mesh belt has irregularities on its surface.

Additionally, one or more of the following embodiments are provided in accordance with further aspects:

(ii) Both the first and second mesh belts may be bent downwards by the lower surface of the injection unit.

(iii) The second mesh belt may be harder than the first mesh belt and only the first mesh belt may be bent downwards by the lower surface of the injection unit.

(iv) A pair of feed rolls spaced from each other by a given distance in the machine direction may be located below regions of the conveyor facing the injection unit so that the conveyor is slightly uplifted by the pair of feed rolls and thereby the regions of the second mesh belt are subjected to a tension higher than that to which the remaining region of said conveyor facing said injection unit is subjected wherein the lower surface of the injection unit comes in slidable contact with the first mesh belt in the region.

The remaining region of said conveyor facing said injection unit is preferably located between the feed rolls in the machine direction.

(v) The injection orifices are preferably provided in a section of the lower surface of the injection unit that is arranged to contact the first mesh belt.

(vi) The lower surface of the injection unit as a whole is preferably convex downwards and contacts the first mesh belt at the lowermost point of the lower surface of the injection unit.

(vii) The lower surface of the injection unit preferably comprises a central section and an upstream section extending downward from an upstream edge of the injection unit to the central section in the machine direction and the central section being horizontal wherein a border of the central section and the upstream section is curved without any corners.

(viii) The lowermost section is preferably a central section between the upstream section and a downstream section, the downstream section extending upwards from said lowermost section to a downstream edge of said injection unit in said machine direction.

Preferably, a border of said central section and said downstream section is curved without any corners.

(vix) Preferably, the injection orifices are provided in the lowermost section.

(x) Preferably, the section of the lower surface of the injection unit which contacts the first mesh belt is located at a level lower than the level at which the feed rolls contact the second mesh belt.

The lower surface of the injection unit may be located at a level lower than respective central axes of the first and second feed rolls.

(xi) An upper surface of the first mesh belt is preferably higher than the section of the lower surface of the injection unit that is arranged to contact the first mesh belt, on at least the upstream side of the section of the lower surface of the injection unit that is arranged to contact the first mesh belt.

The upper surface of the first mesh belt is preferably higher than the section of the lower surface of the injection unit that is arranged to contact the first mesh belt on both the upstream and downstream sides.

(xii) Preferably, on the upstream side only of the injection unit in the machine direction, a bulkhead is provided to block air flowing from upstream into the region.

(xiii) On each of the upstream and downstream sides of said injection unit in said machine direction, a bulkhead may provided to block air flowing into said region.

(xiv) Each bulkhead may be in slidable contact with the conveyor means. Preferably each bulkhead is in slidable contact with an upper surface of the first mesh belt.

(xv) A heating box may be provided to enclose the injection unit and a region of the conveyor corresponding to the injection unit.

According to the embodiments in the above (ii) to (xv), the features of which may be taken in isolation or in any combination, the advantageous effect(s) set forth at (a) is/are better ensured. Further advantageous effects of the respective embodiments may be obtained as discussed in the respective related descriptions.

1. A work treating apparatus having a machine direction, a cross direction being orthogonal to the machine direction, comprising a conveyor serving to convey a work in said machine direction and an injection unit serving to inject superheated and pressurized steam jets to said work, wherein:
said injection unit has a lower surface provided with a plurality of injection orifices arranged in said cross direction;
said conveyor is flexible and comprises a first mesh belt facing to an upper surface of said work and a second mesh belt facing to a lower surface of said work wherein said first and second mesh belts cooperate with each other to sandwich said work therebetween and to convey said work in said machine direction; and
said lower surface of said injection unit comes in slidable contact with said first mesh belt to bend at least said first mesh belt of said first and second mesh belts downward.

2. The work treating apparatus defined by claim 1, wherein both the first and second mesh belts are bent downwards by the lower surface of the injection unit.

3. The work treating apparatus defined by claim 1, wherein the second mesh belt is harder than the first mesh belt and only the first mesh belt is bent downwards by the lower surface of the injection unit.

4. The work treating apparatus defined by claim 1, wherein a pair of feed rolls spaced from each other by a given distance in said machine direction are located below regions of said conveyor facing said injection unit so that said conveyor is slightly uplifted by said pair of feed rolls and thereby said regions of said second mesh belt are subjected to a tension higher than that to which the remaining region of said conveyor facing said injection unit is subjected, wherein said lower surface of said injection unit comes in slidable contact with said first mesh belt in said region.

5. The work treating apparatus defined by claim 1, wherein the injection orifices are provided in a section of the lower surface of the injection unit that is arranged to contact the first mesh belt.

6. The work treating apparatus defined by claim 1, wherein the lower surface of the injection unit as a whole is convex downwards and contacts the first mesh belt at the lowermost point of the lower surface.

7. The work treating apparatus defined by claim 1, wherein said lower surface of said injection unit comprises a lowermost section and an upstream section extending downward from an upstream edge of said injection unit to said lowermost section in said machine direction and said lowermost section being horizontal wherein a border of said central section and said upstream section is curved without any corners.

8. The work treating apparatus defined by claim 7, wherein the lowermost section is a central section between the upstream section and a downstream section, the downstream section extending upwards from said lowermost section to a downstream edge of said injection unit in said machine direction.

9. The work treating apparatus defined by claim 7, wherein the injection orifices are provided in the lowermost section.

10. The work treating apparatus defined by claim 6, wherein the section of the lower surface of the injection unit which contacts the first mesh belt is located at a level lower than the level at which the feed rolls contact the second mesh belt.

11. The work treating apparatus defined by claim 1, wherein an upper surface of the first mesh belt is higher than the section of the lower surface of the injection unit that is arranged to contact the first mesh belt, on at least the upstream side of the section of the lower surface of the injection unit that is arranged to contact the first mesh belt.

12. The work treating apparatus defined by claim 1, wherein, on the upstream side only of said injection unit in said machine direction, a bulkhead is provided to block air flowing from upstream into said region.

13. The work treating apparatus defined by claim 1, wherein, on each of the upstream and downstream sides of said injection unit in said machine direction, a bulkhead is provided to block air flowing into said region.

14. The work treating apparatus defined by claim 12, wherein each bulkhead is in slidable contact with said conveyor means.

15. The work treating apparatus defined by claim 1, wherein a heating box is provided to enclose said injection unit and a region of said conveyor corresponding to said injection unit.
